(19) United States
(12) Patent Application Publication
(10) Pub. No.: US 2018/0121826 A1
(43) Pub. Date: May 3, 2018

(54) Compositional Learning Through Decision Tree Growth Processes and A Communication Protocol

(71) Applicant: Michael Alexander Nugent, Santa Fe, NM (US)

(72) Inventor: Michael Alexander Nugent, Santa Fe, NM (US)

(73) Assignee: Knowm Inc, Santa Fe, NM (US)

(21) Appl. No.: 15/337,408

(22) Filed: Oct. 28, 2016

(51) Int. Cl. G06N 99/00; G06N 3/063

(52) U.S. Cl. CPC G06N 99/005; G06N 3/063

(57) ABSTRACT

A communication protocol is disclosed that enables multiple decision tree forest modules arranged in a compositional network to grow in a coordinated way so as to reduce error as measured by an arbitrary classification process utilizing spike encodings from any of the decision trees forest modules. The disclosed solution to compositional machine learning is agnostic to both the hardware methodology used to implement it, as well as the local decision processes that power nodes in the decision trees. Any number of computing systems based on different technologies and physical arrangements can be built that will coordinate in solving arbitrary compositional learning problems, so long as the communication protocol is enforced.

### TECHNICAL FIELD

Embodiments are related to artificial intelligence systems, machine learning and neuromorphic electronics. Embodiments are further related to a communication protocol for coordinating multiple decision tree processes arranged in compositional architectures.

### BACKGROUND OF THE INVENTION

Artificial intelligence (AI), deals with the science of making machines intelligent. Machine intelligence is a catalyzing technology with world-changing consequences. Intelligence is defined as “the ability to acquire and apply knowledge and skills.” Intelligence is intimately related to (or is) learning. Learning can be interpreted from an information or computer-science perspective, which focuses on the algorithms used to adjust parameters that encode the knowledge acquired during the learning process. This approach has yielded useful algorithms. Learning can also be interpreted from a physics-based (physical) perspective, which leads to insight regarding the implementation of machine intelligence at high Space, Weight and Power (SWaP) efficiencies. Both interpretations are important for the realization of powerful artificial intelligence.

It takes energy to move data around. In integrated circuits we can move data with electrons on metal wires or, more recently, with photons in waveguides. Photons are optimal for long-distance communication but they fail for short-distance communication. We cannot compute directly with photons because they do not interact, so we must couple them to material that can interact, namely, electrons. It takes energy and space (the circuit) to convert from electrons to photons and back again. The result of this is that optical communication does not help if we do not need to communicate information far before we use it in another computation. This is the case with algorithms such as neural networks or emulations of biological nervous systems.

One common argument against computing architectures which aim to circumvent the [von Neumann Bottleneck] (https://en.wikipedia.org/wiki/Von_Neumann_architecture) such as quantum computing and physical neural networks, is that Moore's Law will continue uninterrupted and computers will be fast enough to accelerate any algorithm. This argument is typically used by those with a strictly information or computer science background. The argument is invalid for the physical reasons that the universe is constructed of atoms, and consequently there is a limit to size scaling. No matter what the scale, the core problem limiting the realization of SWaP-efficient intelligence machines is the separation of memory and processing.

While the separation of memory and processing is a design constraint of human computing technology, it does not occur anywhere in Nature including the human brain (and all life). The effects of this constraint can be easily illustrated with a thought experiment.

Suppose we were to simulate the human body at a moderate fidelity such that each cell of the body was allocated to one processor-memory (CPU+RAM) sub-system (core), and the distance between memory and processor was d. We ask: How much energy would be consumed in just the communication between the memory and processor? Each cell is simulated as a collection of state variables, and these variables are encoded as bits in the RAM of each core. Through an iterative processes, data moves from RAM to CPU where updates to the state variables are computed and put back in RAM. The more detailed our simulation, the more state variables we need. On one end of the simulation spectrum we could simulate the position, velocity and configuration of every molecule. On the other end we could only encode if it is alive or dead.

Let's say that each variable is a 32-bit floating-point number and we have N variables to update on each ‘time step’ of the simulation. The number of cells in the human body is approximately 50 trillion. For each time step, we need to update all of N state variables. The more accurate our simulation, the faster we must update it. The time scale for biochemical events ranges from a millisecond for the behavior of discrete cells all the way to femtoseconds for the vibration of molecular bonds. We will pick a nanosecond, which is about the timescale of ribosomes—the molecules that transcribe RNA into proteins. In this case the update rate would then be 1 GHz.

The energy to charge a metal wire goes as

$$\frac{{CV}^{2}}{2} ,$$

where C is the capacitance of the wire and V is the voltage. The capacitance of a wire is proportional to length. The longer it is, the more charge it can soak up. A typical dense wire capacitance in CMOS is 0.2 fF/um. Modern CPU and RAM are separated by about 1 centimeter (0.01 m) and the operating voltage is about 1 Volt. Using the above numbers, we could calculate how much energy would be dissipated in communication between the CPU and processors of all the cores in the super computer.

If we hypothetically set the voltage to V=0.025 Volts and the CPU-memory distance to the diameter of an average cell, d=10⁻⁵ m, the simulation would consume a roughly hundred million Watts. The main take away message is that when you compare biology's power and space efficiency to a simulated exercise on von Neumann architecture, there is a many orders of magnitude difference. After the numbers are run, it should still be clear that to build such a capable computer is not possible on architectures where processor and memory are separate. There simply exists a barrier governed by simple Physics: communication requires time and power. The way around it is to remove the communication, and the only way currently known to do that is to merge memory and processing like biology has done. While computing architectures separating memory and processor have without a doubt been one of the greatest tools humans have ever built and will continue to be more and more capable, it introduces fundamental limitations in our ability to build large-scale adaptive systems at practical power efficiencies. There therefore exists a need for innovations that allow us to build large-scale learning systems that unify memory and processing.

A promising emerging technology that could find application in uniting memory and processing is the “memristor”. In contrast to a linear or nonlinear resistor the memristor has a dynamic relationship between current and voltage including a memory of past voltages or currents. While a great deal of controversy has been generated in regards to the formal definition of a memristor, they key property of use to circuits is that it is a two-terminal variable resistance device that changes resistance as a function of the applied voltage or current. If a periodic voltage is applied a two-terminal device and the current is plotted as a function of voltage, the device is deemed a memristor if the resulting plot forms a pinched hysteresis loop.

Resistive memory devices are useful in hardware circuits since they can be used to represent tunable synaptic weights. Given this, it is clear that other types of devices could be used for this purpose if they posses a memory that alters the devices electrical impedance. One example of this would be a variable capacitive device that changes its capacitance as a function of applied voltage or current history. These are termed “memcapacitors”. Another example would be an chemically mediated device that stores energy as a battery does and that changes its electrical impedance as a function of applied voltage or current history. Such a device could be used as the basis of a state-holding element that can directly configure a circuit, and thus be used to unite memory and processing. We will call all such devices capable altering their electrical impedance as a function of the history of applied voltage or current a “mempedance element”.

Machine learning is the subfield of computer science that explores algorithmic approaches to learning tasks from examples, rather than through explicit programming. Many algorithms have been invented, and many new ones are invented each year. Some examples of the most popular ML algorithms include Linear Regression, k-Means, SVMs, Random Forests, Gradient Boosted Decision Trees, Naive Bayes, and Artificial Neural Networks trained utilizing the Back Propagation of Error (BackProp) algorithm.

BackProp is an elegant and powerful machine-learning algorithm. A key property of BackProp is that an arbitrary error signal from any point in a network can serve as an ‘entry point’ for an error minimization process that can reach a whole network. Through the backward propagation of the error signal, weights distributed over the network can be adjusted to minimize the error signal. So long as the modules making up the components of a network are differentiable functions, BackProp can optimize them. This modular property leads to programming frameworks, where the implementation details of computing derivatives and back-propagating error signals is largely automated and the users can concern themselves with specific application-domain issues like network architectures and training. The rise of frameworks coupled to accelerator hardware like GPUs has led to the field of “Deep Learning”, which has resulted in numerous advances in areas such as image recognition and speech processing. The key property that makes deep learning work is that a network with multiple levels of processing, i.e. ‘layers’, can be learned. In situations where a hierarchical or nested structure exists to patterns, the best structure for detecting those patterns is also hierarchical and thus ‘multi-layer’; the output of one layer or module is sent to the input of another layer or module. The BackProp algorithm has been shown to be capable of training these multiple layers or modules. Consequently BackProp has become a popular and successful algorithm. Many attempts are currently underway to map the BackProp algorithm to dedicated integrated circuitry so as to increase SWaP performance. The challenge is to go from a mathematical construct to a physical (circuit based) construct. Attempts must contend with numerous challenges, such how network topology and learning are efficiently mapped to hardware in the face of fabrication variance and intrinsic circuit noise, as well as how data is communicated within and across chips.

A Decision Tree (DT) is very useful in ML and can be constructed in a number of ways. The primary drawback of a DT is that, if its output is used as the basis of classification, the result is poor generalization performance on data it has never seen before. A simple solution to this problem is to combine more than one uniquely or randomly constructed DT, as is done in the Random Forests algorithm. A number of algorithms for decision tree construction have been proposed, and variants include the Gradient Boosted Decision Trees algorithm, which has shown great promise across many ML benchmarks.

Given the success of deep representations, the question naturally arises: are decision trees “deep”? The answer is ‘no’, as ‘depth’ refers to the architectural depth. This is distinctly different to the tree depth. In a decision tree, each node in the tree receives the same input. What nodes are processed in the tree determines the path up the tree, which constitutes the trees output. The process is inherently discriminative, acting to cut up the input phase-space into a dense hierarchical binary representation. This is at odds with composition learning, where the output of one module becomes the input to another and internal representations can be formed.

The importance of compositional learning has been illustrated in the case of digital multiplication of n-bit integers. The circuit can be achieved in two ways. Either an exponential number of gates can be used in a shallow two-layer structure, or efficiently with a circuit of O(log n). That is, while a shallow architecture is capable of representing the same function as a deeper architectures, the later may be much more efficient and simpler. Simpler descriptions typically lead to better generalization performance in ML. Thus, when data lends itself to compositional description, for example in vision processing where edges are combined to form shapes which are combined to form objects, it is beneficial if the ML algorithm is capable of learning a compositional architecture because it will generalize better to data it has never seen. This can be largely attributed to the fact that the co-positional description is simpler and more efficient.

Distributed representations are important in compositional learning because they provide expressive power and consequently the ability to generalize or interpolate on unseen data. In the case of a single decision tree, it is clear that its output is not a distributed representation but rather a local learner in the sense that the path taken by the decision tree is representative of a discrete binning of the input phase space. However, as Yoshua Bengio has pointed out, if we consider the output of a tree to be an integer specifying the DT leaf or path, then we can consider the output of a DT Forest (DTF) as the encoding of a vector whose elements are these integers, one per tree in the forest. This is a distributed representation, which can express a number of configurations possibly exponential in the number of trees. This is evident in the ability of DT Forests to generalize well to unseen data while individual DT do not.

A central processing unit (CPU) is the electronic circuitry within a computer that carries out the instructions of a computer program by performing the basic arithmetic, logical, control and input/output (I/O) operations specified by the instructions. The term “CPU” refers to a processor, more specifically to its processing unit and control unit (CU), distinguishing these core elements of a computer from external components such as main memory and I/O circuitry. The form, design and implementation of CPUs have changed over the course of their history, but their fundamental operation remains almost unchanged. Principal components of a CPU include the arithmetic logic unit (ALU) that performs arithmetic and logic operations, processor registers that supply operands to the ALU and store the results of ALU operations, and a control unit that orchestrates the fetching (from memory) and execution of instructions by directing the coordinated operations of the ALU, registers and other components.

Most modern CPUs are microprocessors, meaning they are contained on a single integrated circuit (IC) chip. An IC that contains a CPU may also contain memory, peripheral interfaces, and other components of a computer; such integrated devices are variously called microcontrollers or systems on a chip (SoC). Some computers employ a multi-core processor, which is a single chip containing two or more CPUs called “cores”.

Array processors or vector processors have multiple processors that operate in parallel, with no unit considered central. A vector processor or array processor is a central processing unit (CPU) that implements an instruction set containing instructions that operate on one-dimensional arrays of data called vectors, compared to scalar processors, whose instructions operate on single data items. Vector processors can greatly improve performance on certain workloads, notably numerical simulation and similar tasks.

Most commodity CPUs implement architectures that feature instructions for a form of vector processing on multiple (vectorized) data sets, typically known as SIMD (Single Instruction, Multiple Data). Vector processing techniques also operate in video-game console hardware and in graphics accelerators such as GPUs (Graphics Processing Units).

GPUs are efficient at manipulating computer graphics and image processing, and their highly parallel structure makes them more efficient than general-purpose CPUs for algorithms where the processing of large blocks of data is done in parallel. In a personal computer, a GPU can be present on a video card, or it can be embedded on the motherboard or—in certain CPUs—on the CPU die.

It is becoming common to use a general purpose graphics processing unit (GPGPU) as a modified form of stream processor (or a vector processor), running compute kernels. This concept turns the computational power of a modern graphics accelerator's shader pipeline into general-purpose computing power, as opposed to being hard wired solely to do graphical operations. In certain applications requiring massive vector operations, this can yield higher performance than a conventional CPU.

CPU designs may include some multiple instructions for vector processing on multiple (vectorised) data sets, typically known as MIMD (Multiple Instruction, Multiple Data). Such designs are usually dedicated to a particular application and not commonly marketed for general-purpose computing.

For the purpose of this disclosure, we refer to a digital microprocessor as inclusive to CPUs, GPUs, GPGPUs, Vector Processors, Stream Processors or any other digital computing architecture that performs logical operations over bits in one or more memory spaces.

A transistor is a semiconductor device used to amplify or switch electronic signals and electrical power. It is composed of semiconductor material usually with at least three terminals for connection to an external circuit. A voltage or current applied to one pair of the transistor's terminals changes the current through another pair of terminals. Because the controlled (output) power can be higher than the controlling (input) power, a transistor can amplify a signal. Today, some transistors are packaged individually, but many more are found embedded in integrated circuits and form the foundational unit of digital microprocessors.

The metal-oxide-semiconductor field-effect transistor (MOSFET, MOS-FET, or MOS FET) is a type of transistor used for amplifying or switching electronic signals. Although the MOSFET is a four-terminal device with source (S), gate (G), drain (D), and body (B) terminals, the body (or substrate) of the MOSFET is often connected to the source terminal, making it a three-terminal device like other field-effect transistors. Because these two terminals are normally connected to each other (short-circuited), only three terminals appear in electrical diagrams.

The basic principle of the field-effect transistor was first patented by Julius Edgar Lilienfeld in 1925. The main advantage of a MOSFET over other types of transistors is that it requires very little current to turn on (less than 1 mA), while delivering a much higher current to a load (10 to 50 A or more).

In enhancement mode MOSFETs, a voltage drop across the oxide induces a conducting channel between the source and drain contacts via the field effect. The term “enhancement mode” refers to the increase of conductivity with increase in oxide field that adds carriers to the channel, also referred to as the inversion layer. The channel can contain electrons (called an nMOSFET or nMOS), or holes (called a pMOSFET or pMOS), opposite in type to the substrate, so nMOS is made with a p-type substrate, and pMOS with an n-type substrate. In the less common depletion mode MOSFET, detailed later on, the channel consists of carriers in a surface impurity layer of opposite type to the substrate, and conductivity is decreased by application of a field that depletes carriers from this surface layer.

The “metal” in the name MOSFET is now often a misnomer because the previously metal gate material is now often a layer of polysilicon (polycrystalline silicon). Aluminium had been the gate material until the mid-1970s, when polysilicon became dominant, due to its capability to form self-aligned gates. Metallic gates are regaining popularity, since it is difficult to increase the speed of operation of transistors without metal gates. Likewise, the “oxide” in the name can be a misnomer, as different dielectric materials are used with the aim of obtaining strong channels with smaller applied voltages.

An insulated-gate field-effect transistor or IGFET is a related term almost synonymous with MOSFET. The term may be more inclusive, since many “MOSFETs” use a gate that is not metal, and a gate insulator that is not oxide. Another synonym is MISFET for metal-insulator-semiconductor FET. The MOSFET is by far the most common transistor in both digital and analog circuits, though the bipolar junction transistor was at one time much more common.

Complementary metal-oxide-semiconductor (CMOS) is a technology for constructing integrated circuits. CMOS technology is used in microprocessors, microcontrollers, static RAM, and other digital logic circuits. CMOS technology is also used for several analog circuits such as image sensors, data converters, and highly integrated transceivers for many types of communication. CMOS is also sometimes referred to as complementary-symmetry metal-oxide-semiconductor. The words “complementary-symmetry” refer to the fact that the typical design style with CMOS uses complementary and symmetrical pairs of p-type and n-type metal oxide semiconductor field effect transistors (MOSFETs) for logic functions. Two important characteristics of CMOS devices are high noise immunity and low static power consumption. Since one transistor of the pair is always off, the series combination draws significant power only momentarily during switching between on and off states. Consequently, CMOS devices do not produce as much waste heat as other forms of logic, for example transistor-transistor logic (TTL) or NMOS logic, which normally have some standing current even when not changing state. CMOS also allows a high density of logic functions on a chip. It was primarily for this reason that CMOS became the most used technology to be implemented in VLSI chips.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is one aspect of the present invention to provide for a growth communication protocol between modules formed of decision tree forest arranged in a compositional manner.

It is another aspect of the disclosed embodiments to provide for a computing substrate composed of a number of units arranged in multiple physical configurations that each obey a growth communications protocol.

It is a further aspect of the present invention to provide liquid and/or air cooling mechanisms to an artificial intelligence system that obeys a communications protocol.

The aforementioned aspects and other objectives and advantages can now be achieved as described herein. A learning system is disclosed formed of connected modules, where each module contains one or more decision trees. Each decision tree is capable of growth. A growth communication protocol is used to assure that decision trees in different modules can coordinate their growth so as to learn a compositional transfer function.

### BRIEF DESCRIPTION OF THE DRAWINGS

The accompanying figures illustrate the disclosed embodiments and, together with the detailed description of the invention, serve to explain the principles of the disclosed embodiments.

FIG. 1 illustrates a schematic diagram showing a decision tree process, in accordance with the disclosed embodiments;

FIG. 2 illustrates a schematic diagram showing decision tree processes acting as spike encoders for a classifier that generates error signals, in accordance with the disclosed embodiments;

FIG. 3 illustrates a schematic diagram of multiple decision tree processes arrayed in a compositional structure, demonstrating how tree growth leads to uncertainties in the evaluation of down-stream decision tree processes, in accordance with the disclosed embodiments;

FIG. 4 illustrates a schematic diagram of multiple decision tree processes arrayed in a compositional structure, demonstrating a solution to the problem illustrated in FIG. 3 that we call the growth communication protocol, in accordance with the disclosed embodiments;

FIG. 5 illustrates a schematic diagram of multiple decision tree processes arrayed in a compositional structure with multiple classifiers utilizing the output spike encodings of a subset of the decision trees as well as a configuration process used to increase the efficiency of decision tree growth within the network, in accordance with the disclosed embodiments;

FIG. 6 illustrates a schematic diagram of synaptic hardware resources of two designs that obey the growth communication protocol, in accordance with the disclosed embodiments;

FIG. 7 illustrates a schematic diagram of a grid of synaptic hardware resource cores that obey the growth communication protocol that communicate with other cores via a communication resource, in accordance with the disclosed embodiments;

FIG. 8 illustrates multiple schematic diagrams of synaptic hardware resource cores that obey the growth communication protocol that are arrayed in various ways in two and three dimensions with communication resources, in accordance with the disclosed embodiments;

FIG. 9 illustrates air and liquid cooling of a synaptic hardware resource that obeys the growth communication protocol, in accordance with the disclosed embodiments;

### DETAILED DESCRIPTION

The particular values and configurations discussed in these non-limiting examples can be varied and are cited merely to illustrate at least one embodiment and are not intended to limit the scope thereof.

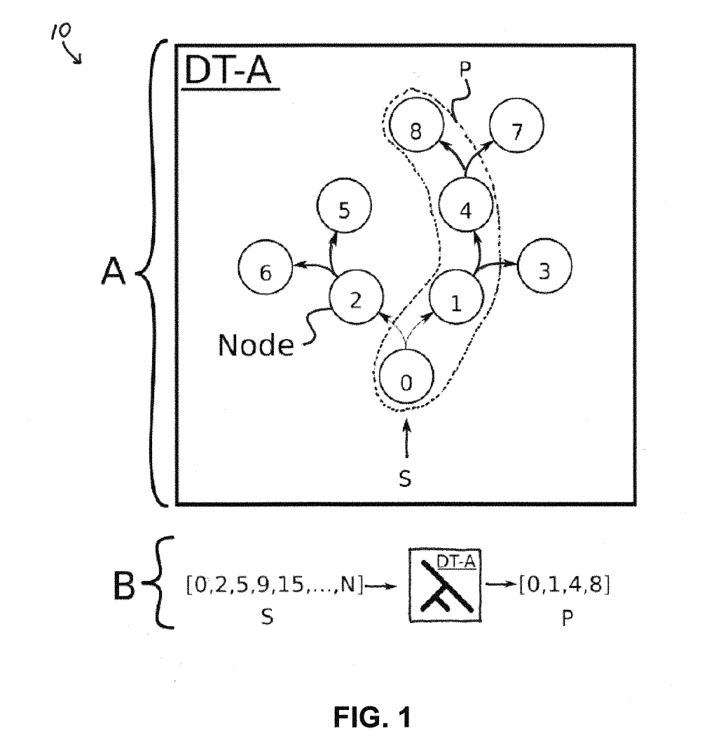

A decision tree (DT) forms a compressed representation of data. The path up the tree, encoded as a leaf node or as a node path, constitutes the tree's output. Each node on the path or route up the tree is a binary question asked of the data, as can be seen in FIG. 1. Input data vector S is given to Node 0, which outputs a binary decision. In this example, the output of Node 1 was ‘true’, which causes Node 1 to evaluate data vector S as ‘false’. This continues until terminal leaf Node 8. The path taken, P, provides an encoding of the input data vector S. Through the addition of more branches, more details can be resolved and the encoding P becomes more detailed. Just as one can resolve a large number of objects via a game of “Twenty Questions”, a DT is capable of summarizing complex data with relatively few questions asked, provided the space of possible questions (the number of nodes) is large or at least picked appropriately for the statistics of the data so that each question approximately cuts the input phase space in half.

The output of a DT is represented as the path P, which is a list of the node identifiers taken from the root node to the leaf node. P is also known as a spike encoding, which is a collection of integers picked from a defined spike space. A good way to picture a spike encoding is as a big bundle of wires (axons), where the total number of wires is the spike space and the set of wires active at any given time is the spike pattern. The algorithms or hardware that convert data into a sparse-spiking representation are called spike encoders. A DT is therefore a spike encoder that converts input pattern S into a spike pattern P. For clarity, some terminology of the spike coding framework are:

Spike: An active spike channel.

Spike Channel: The ‘wires’ or address spaces that carry a spike data.

Spike Space: The total number of spike channels in a spike stream.

Spike Stream: A collection of spike channels used to carry information.

Spike Encoder: Any algorithm or physical circuit that converts data of any type into a spike pattern.

Spike Encoding: A pattern of spikes in a spike space produced by a Spike Encoder. Also called a Spike Pattern.

Spike streams can be combined to form new spike streams. This is advantageous when building a distributed representation of data. For example, a spike encoder SE0 can be used to convert data X into a spike encoding P, S=SE0(X). Another spike encoder SE1 can be used to convert data Y into a spike encoding Q, Q=SE1(Y). Spike encoding P and Q can be joined into a combined spike encoding C=P∪Q. A spike stream of size 50 combined with a spike stream of size 100 would therefore result in a combined spike stream of size 150. Furthermore, a spike stream encoding with 5 active spikes combined with a spike stream encoding of 15 active spikes would result in a spike stream of 20 active spikes. As a spike encoding is built up from more than one component spike encoding, the ability of the combined spike encoding to represent intermediate or interpolated states goes up. It is therefore advantageous is some situations to build a module formed of multiple decision trees, also called a Decision Tree Forest (DTF). For clarity we will define a DTF as two or more decision trees that are combined into one joined spike encoding consisting of the mathematical set union of the two spike streams.

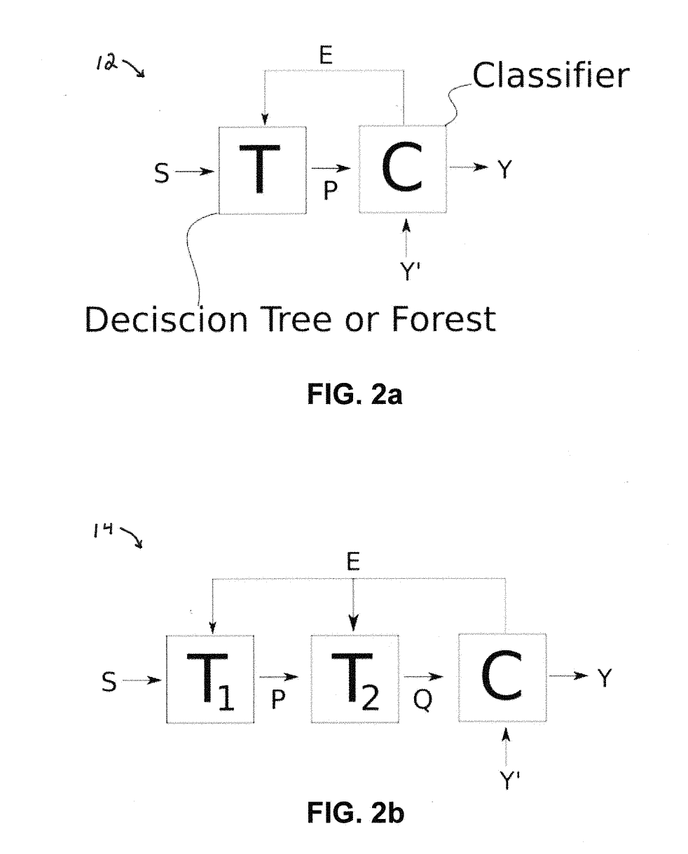

As more nodes are added to a DT the spike encoding becomes more fine-grained. A DT spike encoding P can be used as the basis of a down-stream decision making process, as shown in FIG. 2a. Input pattern S is given to the DT T, which directs it output spike encoding P to supervised classifier C. Classifier C compares its output Y with a supervised input Y′ and, if they differ, generates error signal E. In response to the error signal, T grows by adding additional nodes to path P. The ability of the DT to add more nodes where there is more error (to grow), as measured by C, allows the DT to provide more information that can be used by C to minimize error. A problem occurs, however, when combining multiple DT or DTF modules together to form a multi-module or compositional representation, where the output of one DTF is feed as the input to another, which in turn provides its output to a classifier. For clarification, ‘downstream’ refers to the direction of information flow in the network. For example, module B is downstream of module A if module A's output flows to module B either directly or through one or more intermediate steps, for example: A→B, A→C→B.

The problem with combining multiple DTF into arbitrary networks is show in FIG. 2b. Given two DT, T₁ and T₂, where the output spike encoding P of T₁ is given as the input to T₂, which in turn produces its own spike encoding Q that is given to a classifier C, we ask if such a multi-module system can ‘grow into error’ as a single DT can, providing additional information so C can reduce its prediction error against supervised signal Y′. An analysis reveals a big problem. What happens when T₁ grows such that path P is modified, P→P′ to include an additional node or branch? When T₁ adds additional resolution to its spike encoding via its growth, how does T₂ process this additional resolution?

It is clear that if T₁ adds one or more nodes to its encoding, the nodes of T₂ will see a different spike pattern. Modification of the input pattern P→P′ may change the binary evaluation of any node along path Q, including the root node. Consequently, the addition of only one new branch in T₁ could completely alter the spike encoding Q, which will render any classification of C meaningless.

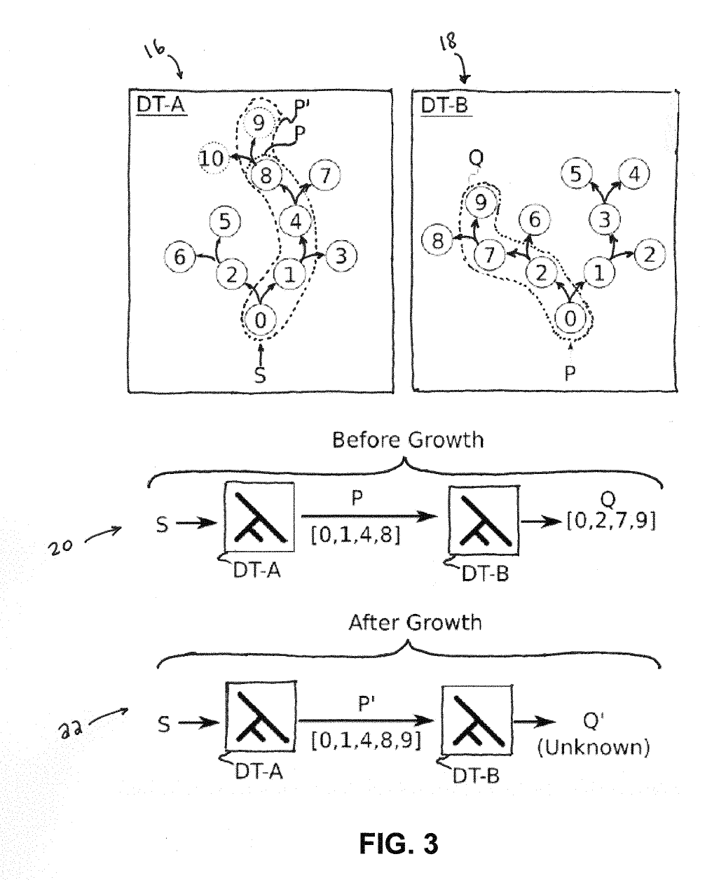

The problem is illustrated in more detail in FIG. 3. Before growth of DT-A, Node 0 of DT-B took as input pattern P and evaluated ‘false’, indicating a route ‘to the left’:

N0(P)=N0([0,1,4,8])→false

If DT-A grows such that P is now modified to produce P′ (for the same pattern S), the evaluation of Node 0 is no longer certain.

N0(P′)=N0([0,1,4,8,9])→Unknown

This condition will occur each time DT-A grows. The result is that DT-B will likely produce a new path route, Q′, that is different—at times maximally different—than its previous path routes. When DT-A grows into an error signal so as to add more resolution to its encoding, the information will be immediately lost through new path routes in DT-B. Consequently, multi-stage or compositional learning cannot occur.

What is needed is a mechanism such that DT-A can add resolution to its encoding by growing more nodes, but without loss of information for downstream DT. How can DT grow across multiple levels of arbitrary compositions without causing (potentially catastrophic) loss of information for downstream DTs? We will first illustrate a solution to the problem with a metaphor and then reduce the solution to a specific communication protocol.

Imagine a number of government bureaucracies each represented as a department in a building, with each department occupying one floor of the building. Suppose that a citizen is requesting something of this bureaucracy and goes to the front desk on the ground floor. A secretary asks a yes/no question to the citizen, the answer of which determines the next bureaucrat that the citizen must talk to within the department. Each bureaucrat asks a question of the citizen, and depending the answer, sends the citizen to another bureaucrat. After visiting ten bureaucrats and answering ten yes/no questions, a form with the questions and answers, not the citizen, is sent to the next department on the second floor. The form lands at the receptionists desk, who takes it and asks a yes/no question of it. Depending on the answer, the receptionist sends the form to other bureaucrats in the department in the same manner as before, who in turn do the same thing. The questions and answers asked of the form are recorded on yet a new form, and the new form is sent to the next department, and so on across all levels of the bureaucracy, until action is taken by the last department, which is responsible for taking action. Alas, by the time the last form reaches the last department, it was misinterpreted and the incorrect action was taken. The citizen must go back to the ground floor of the bureaucracy and try again. The problem now becomes, what rules must be put in place within the departments and the intercommunication between bureaucrats such that the citizens problem will eventually be resolved, if he makes enough requests?

The core problem faced by the departments of the bureaucracy is how to simultaneously summarize information and also communicate the summary to other departments in a coordinated way that does not fail when new information is added. If too few questions are asked in each department, there is the risk of losing the information needed to properly resolve the citizen's request. On the other hand, if more questions are asked, the representation or summary changes, which in turn can change how a down-stream department processes the request. How can a department ask additional questions and communicate the responses in such a way as to aid down-stream processes rather than disrupt them?

One answer to this problem is the following. Each department can adhere to a “consistency contract” such that individuals who received a form before the addition of new information must also receive the form after the addition of new information. By way of example, if Department 0 (D0) passed form F0 to Department 1 (D1), such that the last person in D1 was “Fred”, then it must be the case that after the addition of more information, Fred will see the new information. If F0 is the form before the addition of information (resulting from D0 asking additional questions), and F0′ is the form F0 after the addition of information, then it must be insured that if Fred received form F0 that he also receive F0′. For this to occur, a communication protocol can be put in place. Simply put, any individual within a department can only take action on the answers of a form if the corresponding questions existed before they started at their job. If a question appears that has never been seen before, it must not be utilized to determine who next will see the form. If Fred was the last person in D1 to ask a question of form F0, but now additional information appears, D1 must hire another person to process this additional information. In so doing, department D1 will in turn add additional information that will be sent to D2, and so on. So long as each department adheres to such a consistency contract, the person at the final department responsible for taking actions will eventually obtain the information necessary to make the correct decision and each department will add new staff only as needed to resolve errors in their ability to summarize information for the next department.

Before we provide a specific protocol to resolve our problem, let us first introduce the concept of fixation. Each node in a DT is allowed some time after its creation to adapt its internal configurations in reaction to the information carried over the patterns it is processing. At the point of fixation, one of two conditions must occur. (1) The node must halt all internal modifications by relying on intrinsic stability (non-volatility) of its components or (2) its internal state must be repaired through some active (energetic) mechanism, for example unsupervised AHaH plasticity. To fixate thus refers to the moment when a DT node transitions from a state of change or learning to a state of no change or stasis, irrespective of the mechanisms that enforce the stasis.

In the above bureaucracy example, each DT is representative of a department, each person within the department is representative of a node in the DT, and each form passed between each department is representative of the DT node path. To insure the consistency contract, the following protocol can be enforced:

### Growth Communication Protocol

1. The collection of node identifiers (IDs) along a DT path constitute the DT's output spike encoding.
2. Node IDs increment as new nodes are created within a DT. If a DT of size 8 adds a new node, it should be given the id of ‘9’. Nodes with lower IDs are thus older than nodes with higher IDs.
3. Nodes in a DT must ignore all inputs not present at the time of its fixation. If the largest ID to have occurred on the input of a DT at the nodes creation was ‘8’, then that node will ignore all inputs of ‘9’ or higher.
4. Nodes that have grown child nodes must fixate.

The above protocol could be altered, at the expense of clarity, such that node ID's decrement rather than increment and older nodes have higher IDs. Node filters could be defined accordingly. Such modifications would not constitute novelty but rather would obey the intended purpose of the protocol, which is to unite a collection of DTF modules. While two systems (networks of DTF) each obeying a different version of the protocol would be inoperable with each other, they would also clearly operate with other instantiations of their equivalent type.

If the above rules are obeyed, all DT in a collection of DTs will grow in such a way as to collectively add resolution to their encodings without disrupting down-stream DTs. To make this more precise, let us define a node path filter, F(P,N), that removes node IDs from a node path P if they exceed a given value N. For example:

F([0,1,4,8,9],8)=[0,1,4,8]

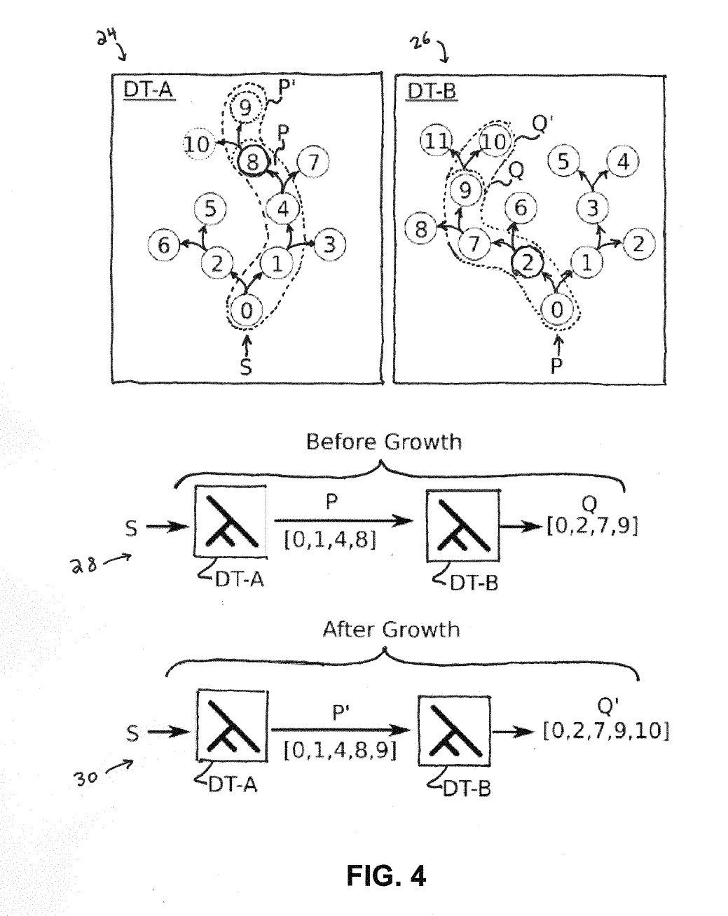

Using FIG. 4 as a reference, we can easily see how obeying the protocol ensures down-stream DTs are not disrupted when upstream DTs grow. Before growth, DT-A took input S and returned node path P=[0,1,4,8]. Let us assume that nodes 0 through 9 of DT-B were created after the creation of nodes 0 through 8 of DT-A and consequently each maintains a node filter with N=8. After the addition of nodes 9 and 10 in DT-A, pattern S is transformed into node path P′. Since F(P′,8)=F([0,1,4,8,9],8]=[0,1,4,8]=P, it is clear that the node path in DT-B will terminate at node 9, since each node along the path [0,2,7,9] will receive the same input it did before P became P′. When DT-B adds nodes 10 and 11, the highest node ID to have been received at that time would be 9. Nodes 10 and 11 will receive the full node path P′. In other words, nodes 10 and 11 of DT-B become specialists capable of acting on the new information produced by nodes 9 and 10 of DT-A. All nodes created in DT-B before the addition of nodes in DT-A are blind to the information.

If we wish to grow the DT of the network to reduce the error generated by some arbitrary classifier utilizing any of the network encodings, we can accomplish this by sending the original error-producing pattern into the network and trigger terminal DT nodes to grow. This can occur through an explicit communication to grow, or also be made intrinsic to node activations. That is, after “x” activations a node may split to add two child nodes, regardless of external signals. This leads to a very interesting consequence. Reprocessing patterns that generated error will cause the network of DTs to grow in such a way as to add additional resolution to the encodings that led to error. The more errors are replayed to the network, the more resolution is given to the errors. In this way, an arbitrary network of DTs can grow to reduce error signals without having to back-propagate signals or perform non-local computation during learning.

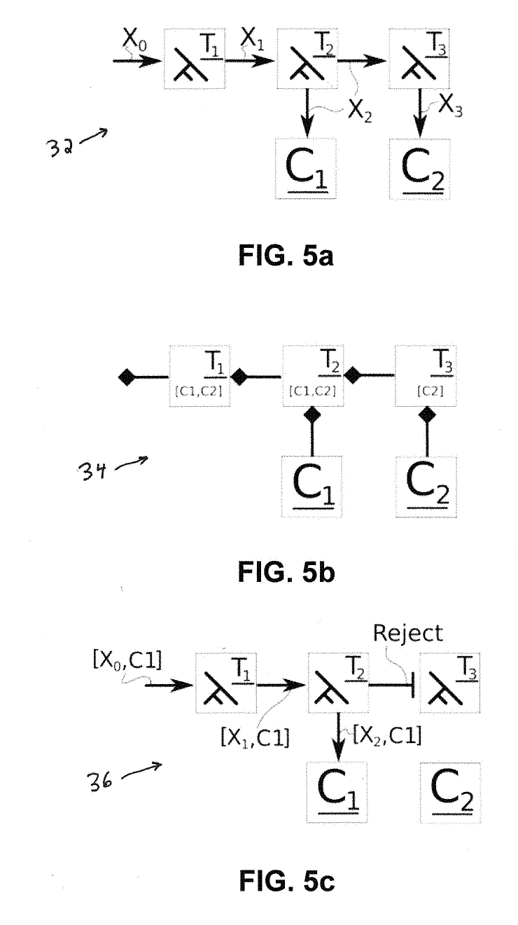

It is advantageous to join the output of multiple DTs (a DTF) into one composite spike stream because the representation has higher expressive power more suited for composable representations. Each module in a compositional network such as that shown in FIG. 5 may thus have more than one DT with output spike streams joined, thus forming a DTF (a decision tree forest). In this case, it is necessary for the mechanism that joins the spike streams to also obey the communication protocol. Specifically, the output spike channel identifiers from the joined spike stream must increment such that spike channels that became active at a later time receive higher spike channel identifiers. This can be accomplished with the use of cache memory. Given two spike streams S_{A} and S_{B} joined to form spike stream S_{C}, the cache can form a mapping between the spike channels of S_{A} and S_{B} and the output spike stream S_{C} such that the output spike channel index starts from ‘0’ and increments until a value that is the sum of the spike spaces S_{A} and S_{B}. For example, if we denote the spikes of spike stream ‘S_{A}’ at time ‘0’ as S_{A}(t=0):

S_{A}(t=0)=[2,5]

S_{B}(t=0)=[5,8]

Then a cache memory that obeys the protocol would produce a mapping such as the following:

S_{A}:2→S_{C}:0, S_{A}:5→S_{C}:1, S_{B}:5→S_{C}:2, S_{B}:8→S_{C}:3,

where “S_{A}:2→S_{C}:0” denotes that spike channel 2 of spike stream S_{A} is mapped to spike channel 0 of spike stream S_{C}. The cache memory would thus perform the mapping:

S_{A}(t=0)∪S_{B}(t=0)=S₂(t=0)=[0,1,2,3],

where the ∪ symbol denotes the set union operator under the constraint of the cache mapping procedure.

It may be beneficial to back-propagate configuration signals in the case where a network is large and multiple classifiers are used to perform different mappings. In this case, one classifier may experience an error while another classifier does not. It is beneficial to limit growth only to those modules that provide information to the classifier that made the error. This is illustrated in FIG. 5. In FIG. 5a input spike encoding X₀ is passed to DTF T₁, which passes its output spike encoding X₁ to DTF T₂, which passes its output spike encoding X₂ to DTF T₃. Spike encodings X₁ and X₂ are passed to classifiers C₁ and C₂, respectively. During a configuration step, signals are passed from the classifiers backward through the DTF network. During this configuration processes, each DTF writes to memory an identifier for each classifier, for example C1 for classifier C₁ and C2 for classifier C₂. The configuration process informs each DTF of its projective fields, i.e. what classifier is depending on its spike encodings. C1 and C2 in FIG. 4b represent classifier projective fields. During normal operation, the classifier identifiers can be supplied along with the input patterns, for example [X₀,C1] as illustrated in FIG. 5c. The classifier identifiers can then be used to reject spike encodings if the DTF does not contain the classifier in its projective field. This is illustrated in FIG. 5c where spike encoding X₂ is rejected by DTF T₃. In this way, DTFs that do not need to grow do not grow, thus saving resources.

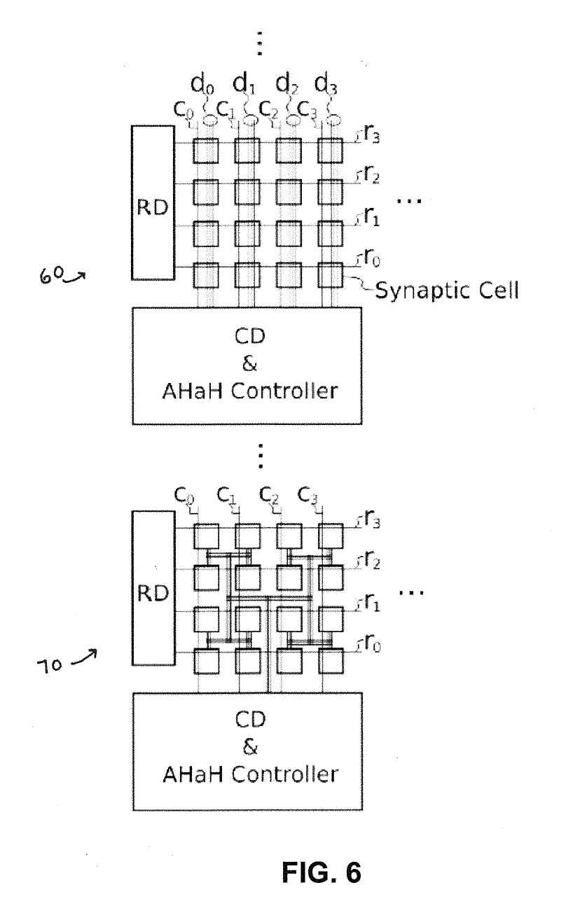

DTF and classifiers can be mapped to a variety of hardware, as illustrated in FIG. 6. FIG. 6a shows a synaptic resource composed of Row Decoders (RD), Column Decoders (CD) and an Anti-Hebbian and Hebbian (AHaH) Controller. The RD can raise or lower the row index electrodes (r₀, r₁, r₂, etc) to select the synaptic cells corresponding the active spikes on a spike encoding. The CD can raise or lower the column index electrodes (c₀, c₁, c₂, etc) to select a column for execution. Drive signals can be broadcast on one or more drive electrodes (d₀, d₁, d₂, etc) corresponding to the active column. The RD, CD and AHaH Controller can drive the electrodes so as to implement the decision tree protocol. Note that this requires that the AHaH Controller maintain internal memory, for example to keep track of each node's identifiers and pointers to child nodes, perform spike stream unions, etc. It is efficient to represent each node in the DTF as a column in the synaptic resource of FIG. 6a so as to prevent additional communication of the spike encoding. Indeed, through the use of memristive technology with integrated selector materials, the synaptic cells of FIG. 6a can be reduced to a crossbar of perpendicular electrodes sandwiching a multi-layer memristive material stack.

FIG. 6b illustrates another embodiment of a synaptic resource similar to that of FIG. 6a except that the drive electrodes are arrayed in a fractal H-Tree structure. The advantage of this structure is that large spike encodings can be attained in small cores due to the 2D array. Another advantage is that drive signals emanating from the AHaH Controller will arrive at equal time to each of the synaptic cells. This is advantageous for synapses composed of memristors that rely on voltage-time products to increment resistance values.

It is clear that numerous hardware embodiments could be created that would implement the growth communication protocol disclosed here. Indeed, this is one such advantage of a protocol. The disclosed solution to compositional machine learning is agnostic to both the hardware methodology used to implement it, as well as the local decision processes that powers nodes in the DTF. That is, any number of computing systems based on different technologies (digital, analog or mixed) can be built that will “work together” in solving arbitrary learning problems, so long as they obey the communication protocol. This has implications in making a transition from existing digital CMOS technology to alternate technologies like memristors and spintronics. The synaptic resource of FIG. 6 could be emulated with digital computing technology such as a CPU, FPGA, GPU or other processor.

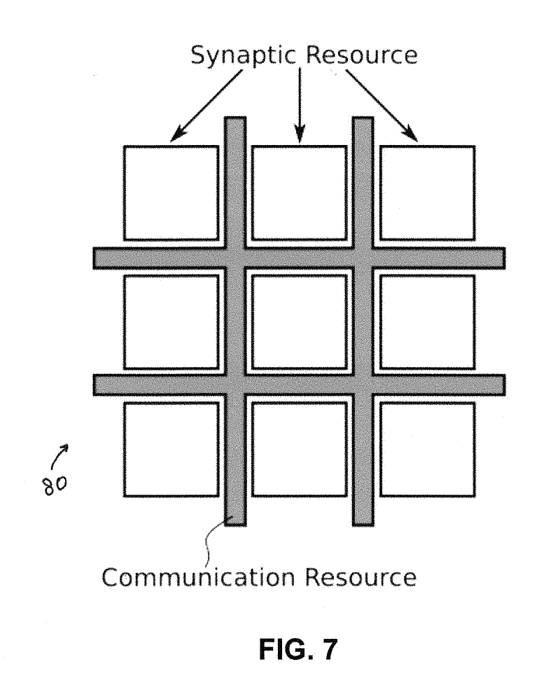

The SWaP efficiencies attained through hardware optimization will be tremendous, especially as the physical structure of a compositional network of DTF is mapped to hardware in such a way as to reduce total communication distance. FIG. 7 shows a synaptic resource ‘core’ that obeys the growth communication protocol embedded in a communication resource. In this embodiment, any core can communicate with any other core by specification of its coordinate in a grid. The function of the communication resource is to transmit spike patterns from a sending to a receiving core. While flexible, the architecture can introduce bottlenecks in processing if cores are not optimized to size and placed close to each other.

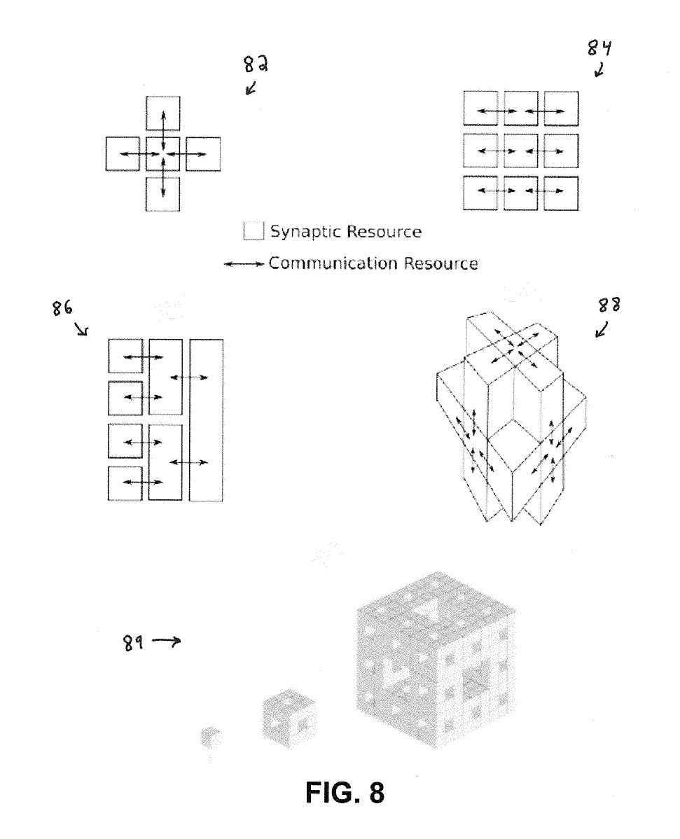

FIG. 8 illustrates three two-dimensional core layouts that can be used to optimize SWaP efficiencies. In FIG. 8a each core can communicate with its nearest neighbors. In FIG. 8b, each core can communicate to other cores in its row or column. Furthermore, we may restrict the direction of communication so that spike encodings progress from right to left or left to right. FIG. 8c illustrates a hierarchical encoding such that the spike encodings of multiple cores project into a single core. Again, the direction of communication may be restricted to one direction so that spike encodings progress only up or down the hierarchy. FIG. 8d illustrates a three-dimensional arrangement such that each core can communicate to its nearest neighbors in both the horizontal but also vertical planes. Due to issues related to cooling of three-dimension arrangement of cores, it may be necessary to introduce cavities such that a heat transfer fluid may permeate the arrangement. One such three-dimensional arrangement is that of a Menger Sponge, which is illustrated in FIG. 8e.

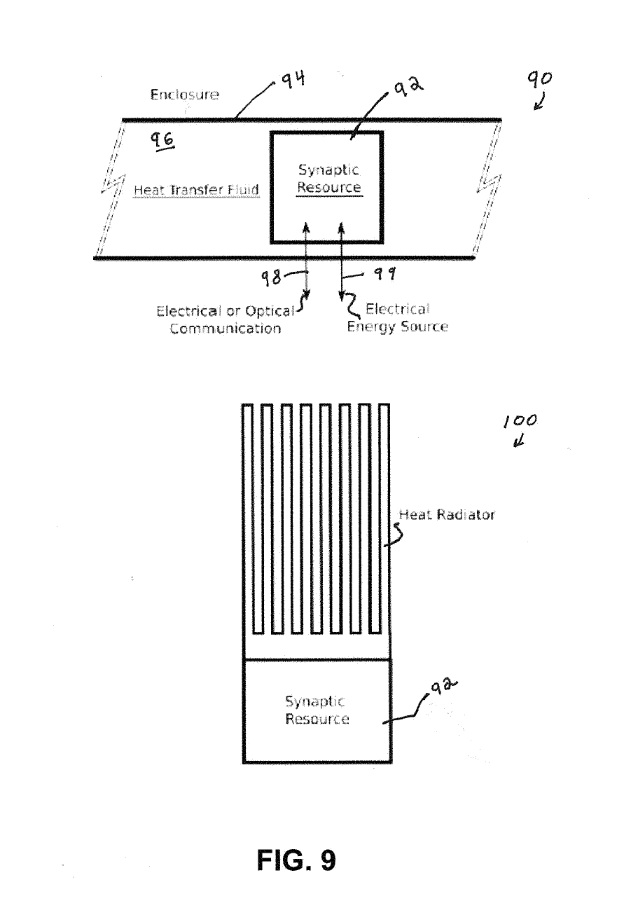

The total power dissipation of a synaptic hardware resource is related to its size, since smaller sizes require for shorter total communication distances. This favors tight three-dimensional integration. However, high density also results in higher heat densities and results in potential cooling issues. This can be resolved through liquid or air cooling. FIG. 9a illustrates a liquid cooling enclosure, where the synaptic hardware resource is placed within an enclosure that circulates a heat transfer fluid while maintaining communication and power conduits. Alternately, the synaptic hardware resource may be coupled to a heat-transfer radiator via a high thermal conductivity material such as thermal paste.

It is clear that numerous other architectural layouts of cores are possible, and that the optimal layout for a specific application will depend on the network topology and the technology it is implemented in.

The particular configurations discussed in these non-limiting examples can be varied and are cited merely to illustrate at least one embodiment and are not intended to limit the scope thereof.

1. A communication protocol for coordinating a growth of at least one decision tree process in a network, said communication protocol comprising:
associating integer identifiers to each node of a decision tree to form a collection of node identifiers or node path, wherein each new identifier in said collection of identifiers or node path is larger than a previous identifier and is ordered by node growth;
utilizing said collection of node identifiers or node path produced during an evaluation of an input spike encoding by said decision tree as its output spike encoding; and
enforcing a constraint that each node in said decision tree ignores all spike channels in its input spike space not active until after a time of a fixation of said node.

2. The communication protocol of claim 1 further comprising a time period for said each node that begins upon a node creation and terminates during said fixation, during which time said node may modify an internal configuration of said node according to a program.

3. The communication protocol of claim 2 wherein with said time period time is measured by a digital counter or an analog counter that increments when a node processes a spike encoding.

4. The communication protocol of claim 2 further comprising an electrical synaptic hardware resource composed of a collection of synaptic cells and a controller circuit that together are used to represent nodes within a decision tree that obeys growth communication of said protocol.

5. The communication protocol of claim 4 wherein said synaptic cells among said collection of synaptic cells are partly or wholly composed of variable resistive material or variable capacitive material.

6. The communication protocol of claim 4 wherein said synaptic cells among said collection of synaptic cells partly or wholly comprise composed of at least one mempedance element.

7. The communication protocol of claim 4 wherein said synaptic cells among said collection of synaptic cells partially or wholly comprise at least one insulated-gate field-effect transistor.

8. The communication protocol of claim 4 wherein said synaptic cells among said collection of synaptic cells partially or wholly comprise at least one transistor.

9. The communication protocol of claim 4 wherein said electrical synaptic hardware resource is simulated via a program running on at least one digital microprocessor that obeys said growth communication protocol of said protocol.

10. The communication protocol of claim 8 wherein said electrical synaptic hardware resource comprises a CPU based computing system.

11. The communication protocol of claim 9 wherein said synaptic electrical hardware resource comprises a GPU based computing system.

12. The communication protocol of claim 1 further comprising a hardware computing architecture comprising at least one synaptic hardware resource and at least one communication resource that together obey said protocol.

13. The communication protocol of claim 12 wherein said hardware computing architecture comprises a hierarchical arrangement.

14. The communication protocol of claim 12 wherein said hardware computing architecture comprises a pipeline arrangement.

15. The communication protocol of claim 12 wherein said hardware computing architecture comprises a grid arrangement.

16. The communication protocol of claim 12 wherein said hardware computing architecture comprises a cube arrangement.

17. The communication protocol of claim 12 wherein said hardware computing architecture comprises a Menger Sponge arrangement.

18. The communication protocol of claim 12 wherein said hardware computing architecture is embedded within an enclosure that provides for a circulation of a heat-transfer fluid that acts to remove waste heat.

19. The communication protocol of claim 12 wherein said hardware computing architecture is coupled to a high thermal connectivity material to provide heat transfer to an enclosed gas.

20. An apparatus, comprising:
a cache memory that performs a set union of spike encodings from two or more spike streams such that resulting spike channels of said set union are assigned incrementing identifiers such that input spike channels that were active at a later time receive larger identifiers in output spike encoding.
